(19) United States
(12) Patent Application Publication
(10) Pub. No.: US 2024/0118456 A1
(43) Pub. Date: Apr. 11, 2024

(54) Shared-Aperture Camera System and Calibration Method

(71) Applicant: Metalenz, Inc., Boston, MA (US)

(72) Inventors: Pawel Latawiec, Cambridge, MA (US); Seyedali Forouzmand, Malden, MA (US); Meng Lu, Boston, MA (US); Mohammad Salary, Boston, MA (US); Anne Janet Milliez, Somerville, MA (US); John W. Graff, Swampscott, MA (US)

(73) Assignee: Metalenz, Inc., Boston, MA (US)

(21) Appl. No.: 18/481,085

(22) Filed: Oct. 4, 2023

Related U.S. Application Data
(60) Provisional application No. 63/378,427, filed on Oct. 5, 2022.

(51) Int. Cl. G02B 1/00; G02B 27/42; H04N 17/00; H04N 23/55

(52) U.S. Cl. CPC G02B 1/002; G02B 27/4205; H04N 17/002; H04N 23/55; H04N 23/951

(57) ABSTRACT

Disclosed herein is various shared-aperture camera systems and calibration methods. One particular shared-aperture camera system includes a polarization imaging device including: an aperture; a first metasurface configured to diffract incident light going through the aperture such that a first polarization of incident light diffracts in a first direction and a second polarization of the incident light diffracts in a second direction; an image sensor; and a planar diffractive lens including a second metasurface configured to focus the first polarization of incident light diffracted in the first direction onto a first portion of the image sensor and focus the second polarization of incident light diffracted in the second direction onto a second portion of the image sensor.

### CROSS-REFERENCE TO RELATED APPLICATIONS

The current application claims priority under 35 U.S.C. 119(e) to U.S. Provisional Application No. 63/378,427, entitled “Shared-Aperture Camera System” to Latawiec et al., filed Oct. 5, 2022, the disclosure of which is incorporated herein by reference in its entirety.

### FIELD OF THE INVENTION

The present invention generally relates to shared-aperture camera systems. More specifically, the present invention relates to shared-aperture polarization camera systems utilizing metasurface elements.

### BACKGROUND

Metasurface elements are diffractive optical elements in which individual waveguide elements have subwavelength spacing and have a planar profile. Metasurface elements have recently been developed for application in the UV-IR bands (300-10,000 nm). Compared to traditional refractive optics, metasurface elements introduce phase shifts onto a light field. Metasurface elements have thicknesses on the order of the wavelength of light at which they are designed to operate, whereas traditional refractive surfaces have thicknesses that are 10-100 times (or more) larger than the wavelength of light at which they are designed to operate. Additionally, metasurface elements typically have no variation in thickness in the constituent elements and are able to shape light without any curvature, as is required for refractive optics. Compared to traditional diffractive optical elements (DOEs), for example binary diffractive optics, metasurface elements have the ability to impart a range of phase shifts on an incident light field. At a minimum, the metasurface elements can have phase shifts between 0-2π with at least 5 distinct values from that range, whereas binary DOEs are only able to impart two distinct values of phase shift and are often limited to phase shifts of either 0 or 1π. Compared to multi-level DOE's, metasurface elements do not require height variation of its constituent elements along the optical axis, only the in-plane geometries of the metasurface element features may vary.

### SUMMARY OF THE DISCLOSURE

In some aspects, the techniques described herein relate to a polarization imaging device including: an aperture; a first metasurface configured to diffract incident light going through the aperture such that a first polarization of incident light diffracts in a first direction and a second polarization of the incident light diffracts in a second direction; an image sensor; and a planar diffractive lens including a second metasurface configured to focus the first polarization of incident light diffracted in the first direction onto a first portion of the image sensor and focus the second polarization of incident light diffracted in the second direction onto a second portion of the image sensor.

In some aspects, the techniques described herein relate to a polarization imaging device, further including a bandpass filter positioned between the planar diffractive lens and the image sensor.

In some aspects, the techniques described herein relate to a polarization imaging device, wherein the first metasurface is positioned within an opening of the aperture.

In some aspects, the techniques described herein relate to a polarization imaging device, wherein the aperture and the first metasurface are positioned on a same surface of a substrate.

In some aspects, the techniques described herein relate to a polarization imaging device, wherein the aperture and the first metasurface are positioned on a surface of the substrate closest to the incident light.

In some aspects, the techniques described herein relate to a polarization imaging device, wherein the aperture and the first metasurface are positioned on a surface of the substrate opposite to the incident light.

In some aspects, the techniques described herein relate to a polarization imaging device, wherein the first metasurface is further configured to pass a zero order light.

In some aspects, the techniques described herein relate to a polarization imaging device, wherein the planar diffractive lens is further configured to focus the zero order light onto a third portion of the image sensor.

In some aspects, the techniques described herein relate to a polarization imaging device, wherein the first metasurface directs both the zero order light and the second polarization of incident light in the same direction.

In some aspects, the techniques described herein relate to a polarization imaging device, wherein the planar diffractive lens focuses both the zero order light and the second polarization of incident light onto the second portion of the image sensor.

In some aspects, the techniques described herein relate to a polarization imaging device, wherein the image sensor has a smaller width than the width of the aperture and/or the planar diffractive lens.

In some aspects, the techniques described herein relate to a polarization imaging device, further including: a first substrate, wherein the planar diffractive lens is positioned on the first substrate a reflective surface positioned on the first substrate, wherein the backside of the aperture is reflective, and wherein the reflective surface and the shared aperture create a folded optical path configured to fold the diffracted light.

In some aspects, the techniques described herein relate to a polarization imaging device, wherein the reflective surface and/or the reflective backside of the shared aperture include diffractive structures.

In some aspects, the techniques described herein relate to a polarization imaging device, wherein the diffractive structures include metasurface elements.

In some aspects, the techniques described herein relate to a polarization imaging device, wherein the aperture and the first metasurface are positioned on a same surface of a second substrate and wherein the folded optical path passes through the second substrate.

In some aspects, the techniques described herein relate to a polarization imaging device, wherein the reflective surface is positioned to cover a portion of the first substrate, the planar diffractive lens surrounds the reflective surface, and the diffracted light reflects off the reflective surface, reflects off the reflective backside of the aperture and diffracts through the planar diffractive lens.

In some aspects, the techniques described herein relate to a calibration method including: providing a raw image scene with various features each including known polarization signatures; providing a polarization camera configured to diffract different polarizations of light into different portions of an image sensor; sequentially illuminating various sub-field of views (FOVs) of the raw image scene; measuring the incident light on the image sensor from light reflected from each sub-FOV; and identifying a linear operator which corresponds the light sensed by the image sensor for each sub-FOV to the location and polarization of the light reflected off a portion of the raw image scene.

In some aspects, the techniques described herein relate to a calibration method, wherein light incident on different portions of the image sensor translates depending on the position of the sub-FOV.

In some aspects, the techniques described herein relate to a calibration method, wherein the light incident on different portions of the image sensor has an intensity signature based on the polarization of the light reflected from each sub-FOV.

In some aspects, the techniques described herein relate to a calibration method, further including: illuminating a sub-FOV of a second raw image scene; measuring the incident light on the image sensor from light reflected from the sub-FOV of the second raw image scene; and computing the position and polarization of the sub-FOV of the second raw image scene based on the computed linear operator.

### BRIEF DESCRIPTION OF THE DRAWINGS

The description will be more fully understood with reference to the following figures, which are presented as exemplary embodiments of the invention and should not be construed as a complete recitation of the scope of the invention, wherein:

FIG. 1 schematically illustrates an example shared aperture imaging system in accordance with an embodiment of the invention.

FIG. 2 schematically illustrates a shared aperture imaging system in accordance with an embodiment of the invention.

FIG. 3 schematically illustrates a shared aperture imaging system in accordance with an embodiment of the invention.

FIG. 4 schematically illustrates a compact shared aperture imaging system with a folded architecture in accordance with an embodiment of the invention.

FIG. 5 schematically illustrates a compact shared aperture imaging system with a folded architecture in accordance with an embodiment of the invention.

FIG. 6 schematically illustrates an example image sensor utilizing sub-images in accordance with an embodiment of the invention.

FIG. 7 schematically illustrates an example image sensor system utilizing sub-images in accordance with an embodiment of the invention.

FIGS. 8A and 8B illustrate two steps in the calibration technique in accordance with an embodiment of the invention.

FIG. 9 schematically illustrates a calibration process in accordance with an embodiment of the invention.

FIG. 10 is a flow chart illustrating a calibration process in accordance with an embodiment of the invention.

FIGS. 11A-11C illustrate various configurations of the metasurface including a configuration where the metasurface is rotated 45° relative to the sensor axes.

### DETAILED DESCRIPTION

Disclosed herein is a device architecture for polarization imaging applications, where a first metasurface splits incident light into different directions, with intensity dependent on the polarization of the incident light. Depending on polarization, different intensities go into the different directions. The different directions are imaged onto the sensor, and the raw image is then synthesized into an image describing the polarization at each pixel. In some embodiments, the first metasurface is solely a polarization beam splitter or for redirecting portions of the light in more than one direction (e.g. does not apply any lensing), and a second planar lens acts as the imaging lens.

Some embodiments include a compact class of imaging systems. Two planar surfaces of a planar diffractive optic may contain a combination of reflective and diffractive surfaces which may split an incident scene into different directions. In some embodiments, the split of the incident scene may be dependent on some property of the scene (e.g. polarization, wavelength). For example, different polarizations of light may be split into different directions. The different polarizations of light may be right hand circularly polarized light and left hand circularly polarized light. The different polarizations of light may be vertical linear polarized light and horizontal linear polarized light. The different polarizations of light may be different elliptically polarized light at various angles. The different directions extending from this “shared aperture” may then be imaged on a sensor. Because each of the subimages share an aperture, the images may be recombined and properties of the scene may be recovered. This architecture is compact, in that the optical path length is extended by using reflective (or diffractive-reflective) surfaces at different positions.

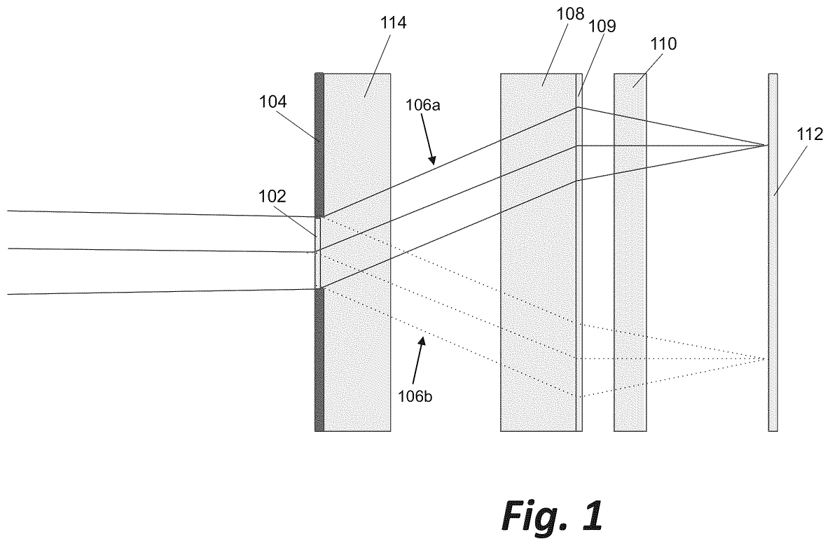

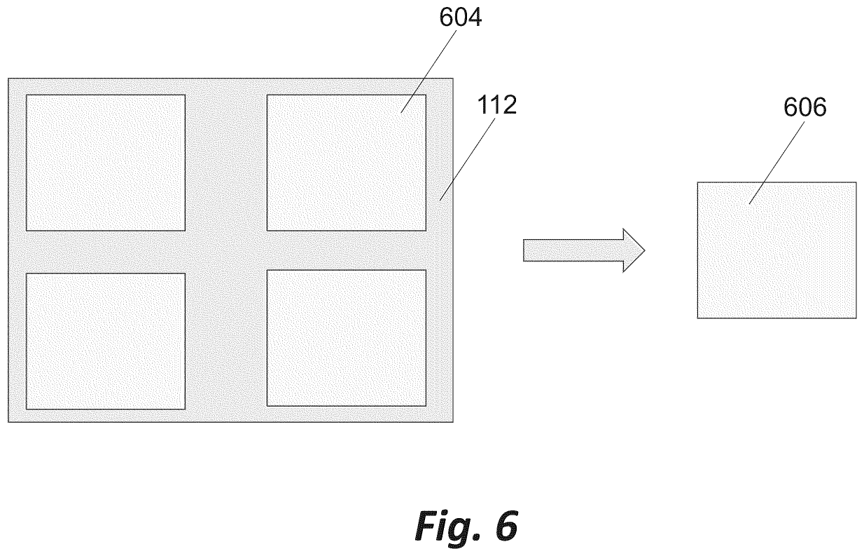

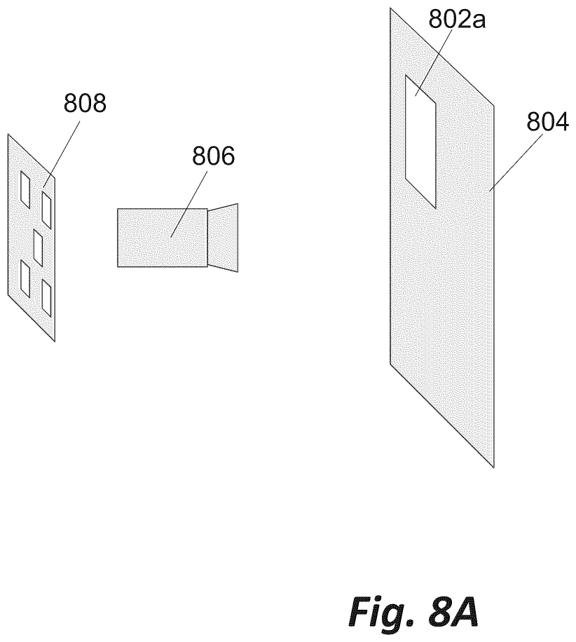

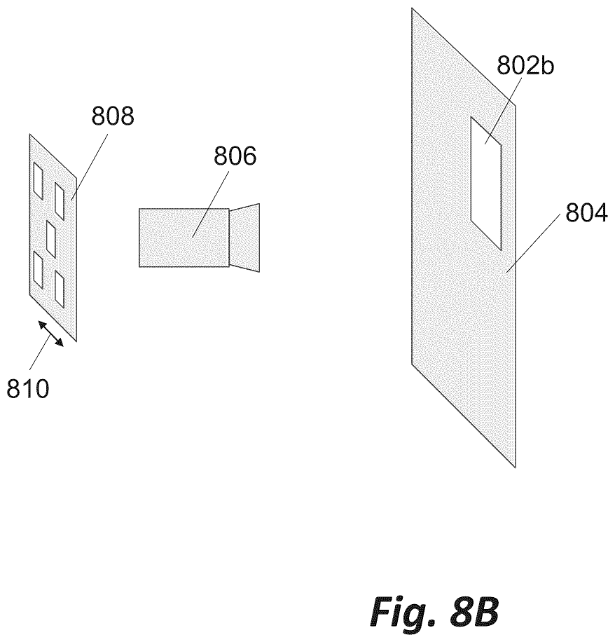

FIG. 1 schematically illustrates an example shared aperture imaging system in accordance with an embodiment of the invention. The imaging system includes a first metasurface 102 within an aperture 104. In some embodiments, the first metasurface 102 may include metasurface elements which include asymmetric cross-sectional shapes, including rectangular, diamond, square, and/or oval cross-section shaped posts. The incident field may be split by the first metasurface 102 into a first sub-image 106a and a second sub-image 106b such that the first sub-image 106a and the second sub-image 106b are directed into different directions. The split incident field may pass through a planar diffractive lens 109 which may include a second metasurface. The planar diffractive lens 109 may be positioned on a substrate 108. The intensity of the first sub-image 106a and the second sub-image 106b may be dependent on the information in the incident field (e.g. wavelength, polarization). In some embodiments, the substrate carrying the first metasurface 102 and the planar diffractive lens 109 may be the same. In some embodiments, the planar diffractive lens 109 may include metasurface elements which include symmetric cross-sectional shapes (e.g. circular cross-section shaped posts), and/or asymmetric cross-sectional shapes (e.g. rectangular, square, diamond and/or oval cross-section shaped posts). In some embodiments, the planar diffractive lens 109 may be a non-metasurface-based element which may be either a refractive element or other type of diffractive element (e.g. a lenslet array). In some embodiments, the first sub-image 106a and the second sub-image 106b may pass through an external bandpass filter 110. The first sub-image 106a and the second sub-image 106b may be incident on an image sensor 112. In some embodiments, the chief rays of the first sub-image 106a may be a first polarization P1 light and the second sub-image 106b may be a second polarization P2 light. While, in the illustrated example, the first metasurface 102 diffracts the incident field into the first sub-image 106a and the second sub-image 106b, the first metasurface 102 may diffract the incident field into more rays. For example, the first metasurface 102 may diffract the incident field into four channels which may be chosen to be non-coplanar on the Poincare sphere. This is illustrated in FIG. 6 (described below) which includes four sub-images in different positions of an image sensor. Also, this is illustrated in FIGS. 8A and 8B which includes different FOVs in an isometric view. The planar diffractive lens 109 may be configured to focus the first polarization 106a of incident light diffracted in the first direction onto a first portion of the image sensor 112 and focus the second polarization 106b of incident light diffracted in the second direction onto a second portion of the image sensor 112. Different examples of metasurfaces which diffract light in different directions based on different properties of light are described in U.S. patent application Ser. No. 18/194,359, entitled “Polarization Sorting Metasurface Microlens Array Device” and filed Mar. 31, 2023, which is hereby incorporated by reference in its entirety for all purposes.

In some embodiments, the first metasurface 102 may be positioned inside the opening of the aperture 104. In some embodiments, the first metasurface 102 may be positioned in front of the aperture 104. In some embodiments, the first metasurface 102 may be positioned behind the aperture 104.

In some embodiments, the second metasurface of the planar diffractive lens 109 may be positioned on the top surface and/or the bottom surface of the substrate 108.

While the first metasurface 102 may diffract the light based on the polarization of the incident light, the first metasurface 102 may also diffract light based on other parameters such as wavelength (e.g. different colors).

In some embodiments, the aperture 104 and the first metasurface 102 may be on the front side or back side of a substrate 114. In some embodiments, the planar diffractive lens 109 may be combined with the bandpass filter 110 with the bandpass filter 110 above or below the planar diffractive lens 109. In some embodiments, the bandpass filter 110 may be separate from the planar diffractive lens 109 and above or below the planar diffractive lens 109. In some embodiments, the bandpass filter 110 may be attached to the back of the substrate 114 opposite the first metasurface 102 and/or the aperture 104. In some embodiments there may be a polarization filter. In some embodiments, the imaging system may include a polarization filter and/or various types of bandpass filters. In some embodiments, the substrates and materials may be different between the various elements. In some embodiments, the image sensor 112 may include various types of sensor and/or may include an array of separated sensors. The array of separate sensors may include individual sensors that are sufficiently far apart so that various sub-images do not overlap. The bandpass filter 110 may be between the last lensing element of the imaging system and the image sensor 112 because it minimizes the angle of the marginal rays in a telecentric design which allows the bandpass filter 110 to have a narrower notch.

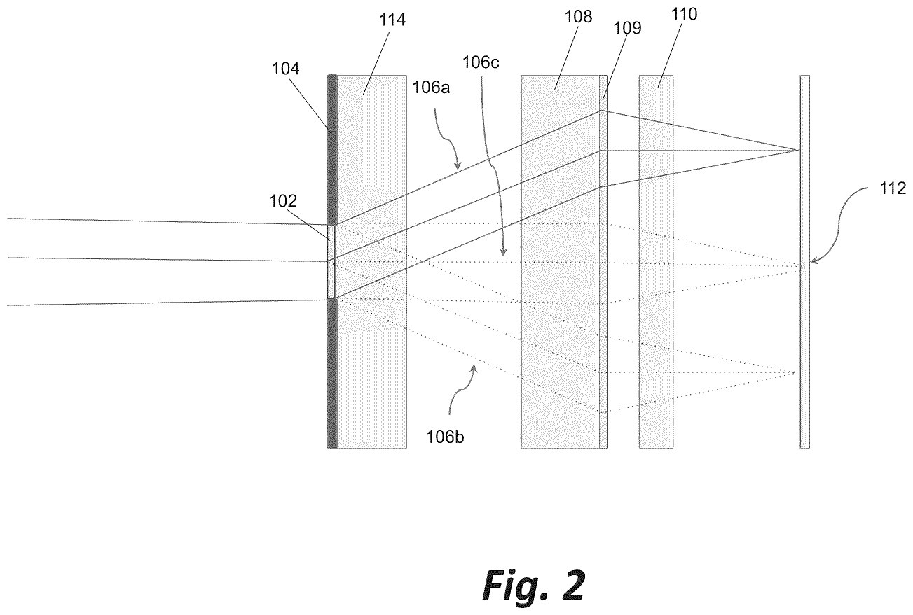

FIG. 2 schematically illustrates a shared aperture imaging system in accordance with an embodiment of the invention. The imaging system shares many identically numbered components with the imaging system described in connection with FIG. 1. The description of these components is applicable to the imaging system of FIG. 2 and the descriptions will not be repeated in detail. The first metasurface 102 may diffract the incident field into the first sub-image 106a and the second sub-image 106b. Also, the first metasurface 102 may pass zero order light 106c. The zero order light 106c may not include lensing function at the first metasurface 102. The zero order light 106c from the first metasurface 102 may be imaged and in-focus at the image sensor 112. The imaged zero order light 106c may be taken into account during calibration and image synthesis. For example, the zero order light 106c may be separately characterized and thus may be subtracted from the other sensed light. The second metasurface 109 may focus the zero order light 106c onto a third portion of the image sensor different than the first portion and second portion of the image sensor.

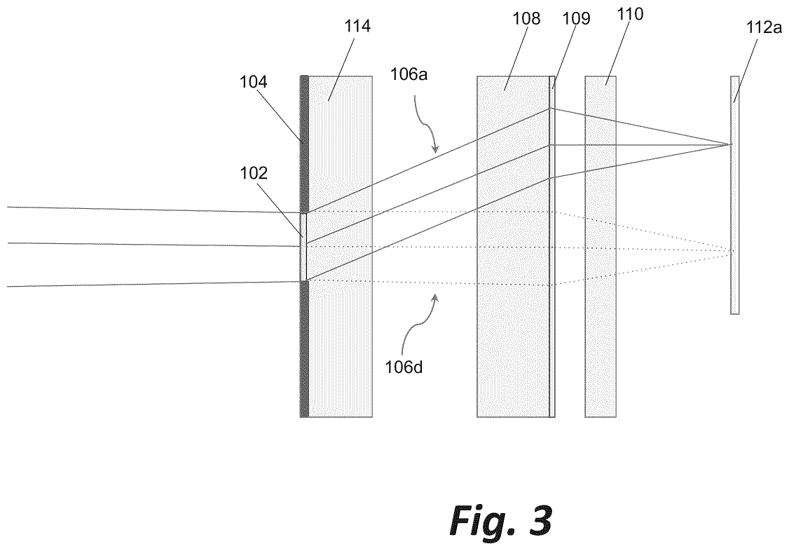

FIG. 3 schematically illustrates a shared aperture imaging system in accordance with an embodiment of the invention. The imaging system shares many identically numbered components with the imaging system described in connection with FIG. 1. The description of these components is applicable to the imaging system of FIG. 3 and the descriptions will not be repeated in detail. The first metasurface 102 may diffract the incident field into a first sub-image 106a. The first metasurface 102 may pass light 106d. The chief rays of the first sub-image 106a may include a first polarization and the passed light 106d may include zero order light and a second polarization light. The first sub-image 106a and the passed light 106d may be incident on an image sensor 112a. The image sensor 112a may be offset such that the image sensor 112a is smaller than the overall size of the aperture 104 and/or the planar diffractive lens 109. Thus, the image sensor 112a may be smaller relative to the image sensor of the device disclosed in FIGS. 1 and 2 which may save costs. This architecture may alleviate the issue of zero order light overlap at the sensor. The offset image sensor 112a may make the zero order image one of the sub-images.

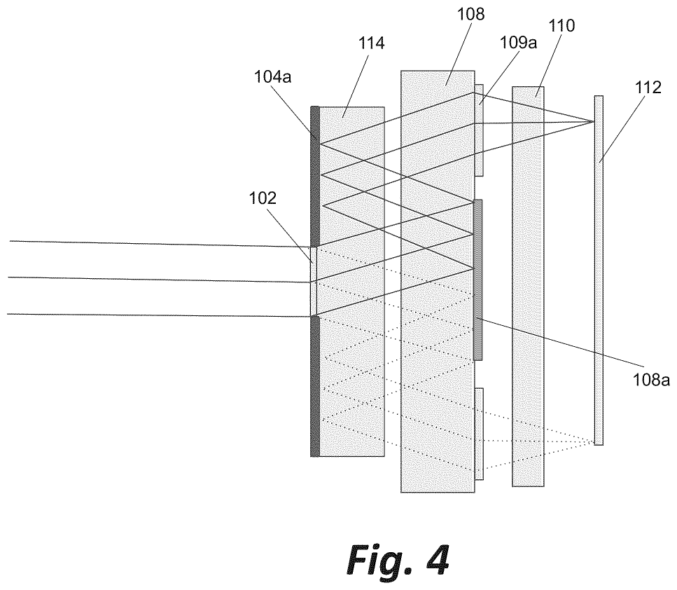

FIG. 4 schematically illustrates a compact shared aperture imaging system with a folded architecture in accordance with an embodiment of the invention. The imaging system shares many identically numbered components with the imaging system described in connection with FIG. 1. The description of these components is applicable to the imaging system of FIG. 4 and the descriptions will not be repeated in detail. The compact shared aperture imaging system may include a folded optical path. The incident field may be diffracted by the first metasurface 102 into a first sub-image 106a and a second sub-image 106b. The intensity of each diffraction order may be dependent on the information in the field (e.g. wavelength, polarization). The first metasurface 102 may be positioned in an aperture 104a. The aperture 104a may include a reflective back side. Further, a reflective surface 108a may be positioned on bottom side of the substrate 108 such that a planar diffractive lens 109a is located surrounding the reflective surface 108a. The planar diffractive lens 109a may include many of the same properties as the planar diffractive lens 109 of FIG. 1 and may include a second metasurface. The reflective backside of the aperture 104a and/or the reflective surface 108a may also have diffractive structures on them, to aid in imaging performance. The diffractive structures may include metasurface elements. The diffractive structure on the reflective surface 108a may provide lensing prior to the lensing performed by the second metasurface of the planar diffractive lens 109a. Further, the diffractive structures on the reflective back side of the aperture 104a may also provide lensing prior to the lensing performed by the metasurface of the planar diffractive lens 109. In some embodiments, the first metasurface 102 may also perform lensing prior to the lensing performed by the metasurface of the planar diffractive lens 109a. While the illustrated folded optical substrate only includes a single reflective bounce off the reflective surface 108a and the reflective back side of the aperture 104a, it has been contemplated that the device may accommodate multiple optical bounces off the reflective surface 108a and the reflective back side of the aperture 104a as well.

In some embodiments, the first sub-image 106a and the second sub-image 106b may be oppositely circularly polarized light. For example, the first metasurface 102 may diffract the incident field into the first sub-image 106a as right circularly polarized (RCP) light and the second sub-image 106b as left circularly polarized (LCP) light. Advantageously, this allows the second metasurface of the planar diffractive lens 109a to be specialized to operate on RCP or LCP-polarized light, improving efficiency and performance. In the case of splitting into more than two paths, some paths may share polarization states.

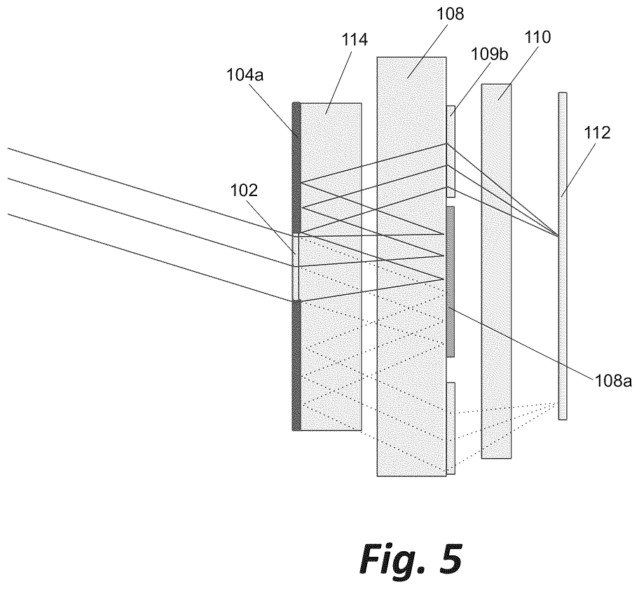

FIG. 5 schematically illustrates a compact shared aperture imaging system in accordance with an embodiment of the invention. The imaging system shares many identically numbered components with the imaging system described in connection with FIG. 4. The description of these components is applicable to the imaging system of FIG. 5 and the descriptions will not be repeated in detail. As illustrated, the first sub-image 106a and/or the second sub-image 106b after the planar diffractive lens 109b may also bend inwards, to fill the center of the image sensor 112 more fully. The planar diffractive lens 109b may be configured to bend the light inwards.

In some embodiments, the shared aperture imaging system described in connection with at least one of FIGS. 1-5 may be incorporated in the back of a display device. For example, the imaging system may image different polarizations of light or different wavelengths of light from in back of the display device. The display device may be an organic light emitting diode (OLED) display or a liquid crystal display (LCD).

FIG. 6 schematically illustrates an example image sensor utilizing sub-images in accordance with an embodiment of the invention. The image sensor 112 may include multiple sub-images 604 which may appear on the image sensor 112. The sub-images 604 may then be synthesized into one synthesized image 606 by combining the different sub-images 604 into a single image. This technique can increase resolution of the imaging system without registration concerns because the images share an aperture. For example, four noisy images may be combined into one less noisy image which may increase the resolution of the one image. Furthermore, building a mapping to a higher-resolution version of one image which is filled in by multiple sub-images.

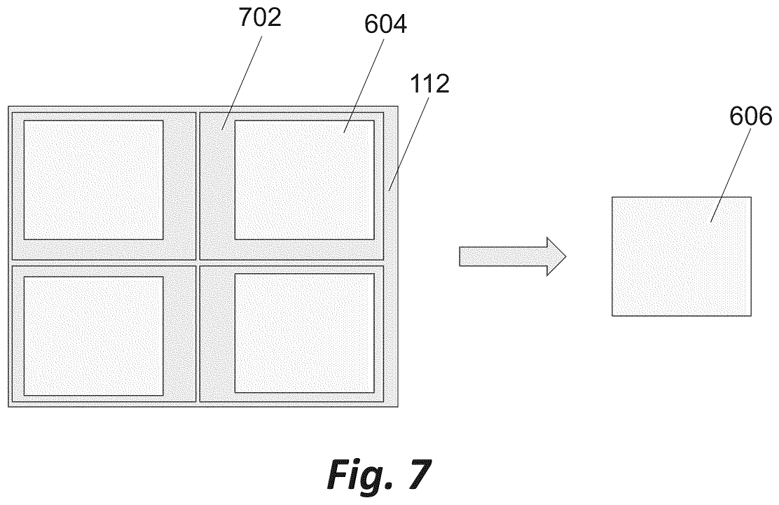

FIG. 7 schematically illustrates an example image sensor system utilizing sub-images in accordance with an embodiment of the invention. The imaging system shares many identically numbered components with the imaging system described in connection with FIG. 6. The description of these components is applicable to the imaging system of FIG. 7 and the descriptions will not be repeated in detail. The image sensor 112 may include filters 702 overlaying the sub-images 604 having additional wavelength filtering capability. Each filter 702 may be tuned to its respective sub-image's nominal wavelength, so each sub-image 604 appears in-focus for the nominal wavelength, avoiding chromatic aberration. The sub-images 604 may then be synthesized into a single color image 606. The sub-images 604 may also be sorted by color due to the action of the first metasurface or other components in the system.

### Example Calibration Technique

This disclosure includes a calibration technique utilizing the imaging sensor systems described above. FIGS. 8A and 8B illustrate two steps in the calibration technique in accordance with an embodiment of the invention. Small segments of a full FOV 804 may be illuminated, varying polarization across. First, in FIG. 8A, a first sub-FOV 802a of a full FOV 804 may be illuminated by a light source of known polarization causing reflected light with a polarization signature. Different sub-FOVs of the full FOV 804 may be produced by a calibration light box which may have a known polarization signature. In some embodiments, different sub-FOVs of the full FOV 804 may be produced by Kohler-like illumination with apertured FOV.

A polarization camera 806 may be positioned to receive the polarization signature. The polarization camera 806 may be one of the shared aperture imaging systems described in connection with FIGS. 1-5. As described above, the polarization camera 806 may diffract different polarizations of light into different portions of an image sensor 808. The different portions of the image sensor 808 may not overlap.

Next, in FIG. 8B a second sub-FOV 802b of the full FOV 804 may be illuminated by a light source of known polarization causing reflected light with a polarization signature. The polarization camera 806 may diffract different polarizations of light into different portions of the image sensor 808. The portions of the image sensor 808 illuminated by the diffracted light from the second sub-FOV 802b may be translated 810 from the diffracted light from the first sub-FOV 802a based on the position of the second sub-FOV 802b.

The positioning of the sub-FOV (e.g. the difference between the position of the first sub-FOV 802a and the second sub-FOV 802b) may cause a translation of the diffracted light on the image sensor 808. Thus, the positioning of the diffracted light on the image sensor 808 may be correlated to the positioning of the sub-FOV.

Further, the distinct polarization of the reflected light from the first sub-FOV 802a or the second sub-FOV 802b may cause different intensities of diffracted light on the image sensor 808 to sensed. Thus, the different intensities of the diffracted light on the image sensor 808 may be correlated to the polarization of the reflected light from the sub-FOV. A linear operator may allow backtracking from the images captured on the image sensor 808 to position and polarization of incident light on the image sensor 808. Combining the different images may then allow for the full FOV 804 to be reconstructed when the full FOV 804 is imaged.

In some embodiments, instead of changing the part of the calibration target that is illuminated, the calibration target is fixed and the camera may be moved around instead. This may have the same effect as changing the field of view being calibrated.

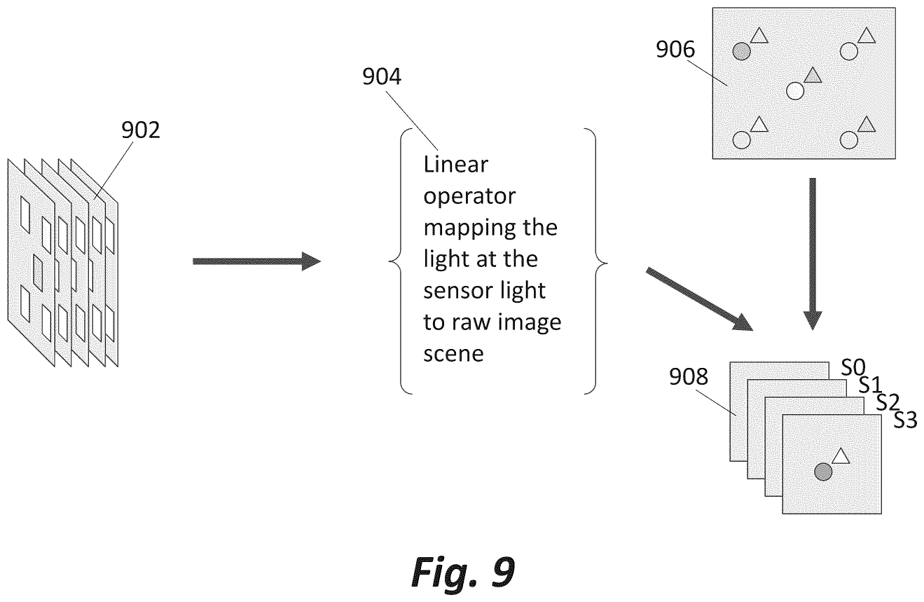

FIG. 9 schematically illustrates a calibration process in accordance with an embodiment of the invention. As discussed in connection with FIGS. 8A and 8B, the different sub-FOVs of the full FOV 804 may produce different translated diffracted light onto different portions of the image sensor 808. A fully previously characterized raw sensor image 906 may be used to solve for a linear operator describing mapping from a scene to raw sensor intensity. A sequence of sensor images 902 with known incident polarization and illuminated sub-FOV may be produced. This sequence of sensor images 902 may be processed using the sequence of sensor images 902 to synthesize and identify scene intensity with “raw” sensor intensity. A linear operator 904 describing mapping from a scene to raw sensor intensity may be used to solve for different raw sensor images 906 at different sub-FOVs. The mapping in the linear operator 904 may be inclusive of Stokes parameters. The raw sensor image 906 may be used to solve the linear system with a calibrated operator. Since the raw sensor image 906 is known including the positioning and polarization intensity of the features 908 of the raw sensor image 906, a correlation may be developed for each of the sensor images 902 with the features 908 of the raw sensor image 906. This correlation may form the basis of the linear operator 904 mapping a particular sensor image 902 to one of the features 908.

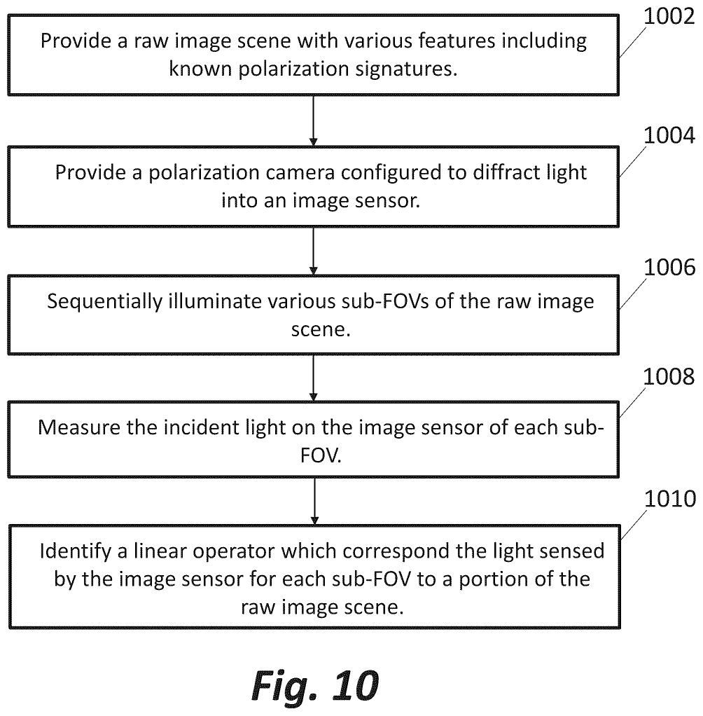

FIG. 10 is a flow chart illustrating a calibration process in accordance with an embodiment of the invention. The process includes providing (1002) a raw image scene with various features including known polarization signatures. The raw image scene may be a 4×P×Q-sized array of different features. The different features each may have different channels for each Stokes parameter.

The process further includes providing (1004) a polarization camera configured to diffract light into an image sensor configured to sense multiple sub-FOVs of the raw image scene. The image sensor may be an N×M sized array. The polarization camera may be one of the shared aperture imaging systems described in connection with FIGS. 1-5.

The process further includes sequentially illuminating (1006) the sub-FOVs of the raw image scene. The sub-FOVs may reflect light with a certain polarization signature back to the polarization camera. Since the raw image scene includes a known polarization signature, the reflected light may also have a known polarization signature. In some embodiments, the illuminating the sub-FOVs may be performed through a synthetic set-up which may include either an apertured light box, moving transverse field stop of camera, or apertured Kohler illumination, such that the projected images of the sub-FOV on the image sensor do not overlap.

The process further includes measuring (1008) the incident light on the image sensor of each of the sub-FOVs. In some embodiments, the polarization camera may include a set of polarization lenses which may modify the polarization of the diffracted light into the image sensor. Due to how the polarization camera works the intensity of each segment in the image sensor may change. For the different sub-FOVs, the diffracted light onto the image sensor may translate based on the positioning of the different sub-FOVs. This translation is described in FIGS. 8A and 8B. For each sub-FOV, the intensity of the diffracted light onto different positions of the image sensor may be based on the intensity of different polarizations of light within the diffracted light. Examples of the general operations of the polarization camera are described in connection with FIGS. 1-5.

The process further includes identifying (1010) a linear operator which corresponds to the light sensed by the image sensor for each sub-FOV to a portion of the raw image scene including various features including known polarization signatures. The portion of the raw image scene may include scene coordinates as given in the synthetic scene set onto pixel coordinates of the image sensor. The scene coordinates may be inclusive of the Stokes parameter. This may be performed by parsing the sequence of calibration images. Thus, the linear operator may correspond each of the sub-FOVs with a real image.

As described above, for the different sub-FOVs, the diffracted light onto the image sensor may translate based on the positioning of the different sub-FOVs. Thus, the positioning of the diffracted light on the image sensor may correspond to the positioning of the different sub-FOVs. Also, the intensity of the diffracted light onto different positions of the image sensor may be based on the intensity of different polarizations of light within the diffracted light. Thus, the intensity of the light on the image sensor may correspond to the polarization of the light of the different sub-FOVs. The polarization of the raw image scene may be known. Thus, a linear operator may be developed which may correlate the light sensed by the image sensor with light of a specific polarization and location.

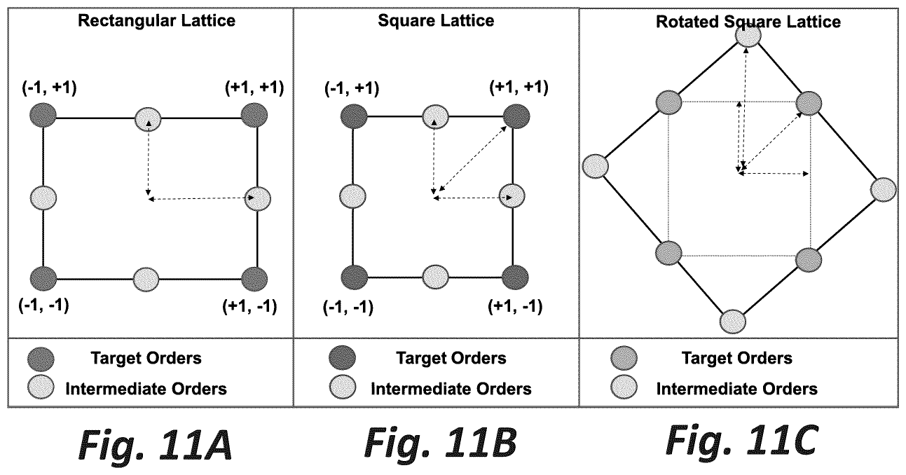

A registration image can be used to identify the relationship between spatial scene coordinates and pixel coordinates of each sub-FOV. A registration image may be an image taken with known features which helps identify how the pixels on the sensor map to field points (e.g. directions the camera is looking). FIGS. 11A-11C illustrate various configurations of the metasurface including a configuration where the metasurface is rotated 45° relative to the sensor axes. The sensor axes may be the axes aligned to the rectangular sides of the sensor. For example, in a rectangular image sensor, the metasurface may be arranged periodically on a lattice. That lattice may also be rectangular or square. FIGS. 11A and 11B illustrate the case where the axes of the lattice are pointed in the same direction as the axes of the sensor. FIG. 11C illustrates the case where the metasurface lattice is rotated by 45°. In this case, the axes of the metasurface lattice are rotated 45° with respect to the sensor lattice. This embodiment may eliminate or reduce the “intermediate” orders, which can be an issue. The intermediate orders may be orders that are within the “support” of the reciprocal space of the lattice but which are not targeted for the design. “Support” may be defined as the domain of a function. Given a lattice the periodic metasurface is defined on, the reciprocal lattice defines what angles the lattice diffracts to. By choosing a square lattice and rotating it 45°, there may be no intermediate orders in certain specific regions. The “Rectangular” and “Square Lattice” illustrated in FIGS. 11A and 11B may be more typical embodiments. However, by rotating the grating lattice 45°, the presence of intermediate orders may be avoided between the target orders. Unwanted intermediate orders may cause intermediate sub-images which negatively impact image quality upon reconstruction.

### DOCTRINE OF EQUIVALENTS

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A polarization imaging device comprising:
an aperture;
a first metasurface configured to diffract incident light going through the aperture such that a first polarization of incident light diffracts in a first direction and a second polarization of the incident light diffracts in a second direction;
an image sensor; and
a planar diffractive lens including a second metasurface configured to focus the first polarization of incident light diffracted in the first direction onto a first portion of the image sensor and focus the second polarization of incident light diffracted in the second direction onto a second portion of the image sensor.

2. The polarization imaging device of claim 1, further comprising a bandpass filter positioned between the planar diffractive lens and the image sensor.

3. The polarization imaging device of claim 1, wherein the first metasurface is positioned within an opening of the aperture.

4. The polarization imaging device of claim 1, wherein the aperture and the first metasurface are positioned on a same surface of a substrate.

5. The polarization imaging device of claim 4, wherein the aperture and the first metasurface are positioned on a surface of the substrate closest to the incident light.

6. The polarization imaging device of claim 4, wherein the aperture and the first metasurface are positioned on a surface of the substrate opposite to the incident light.

7. The polarization imaging device of claim 1, wherein the first metasurface is further configured to pass a zero order light.

8. The polarization imaging device of claim 7, wherein the planar diffractive lens is further configured to focus the zero order light onto a third portion of the image sensor.

9. The polarization imaging device of claim 1, wherein the first metasurface directs both the zero order light and the second polarization of incident light in the same direction.

10. The polarization imaging device of claim 9, wherein the planar diffractive lens focuses both the zero order light and the second polarization of incident light onto the second portion of the image sensor.

11. The polarization imaging device of claim 9, wherein the image sensor has a smaller width than the width of the aperture and/or the planar diffractive lens.

12. The polarization imaging device of claim 1, further comprising:
a first substrate, wherein the planar diffractive lens is positioned on the first substrate; and
a reflective surface positioned on the first substrate, wherein the backside of the aperture is reflective, and wherein the reflective surface and the shared aperture create a folded optical path configured to fold the diffracted light.

13. The polarization imaging device of claim 12, wherein the reflective surface and/or the reflective backside of the shared aperture include diffractive structures.

14. The polarization imaging device of claim 13, wherein the diffractive structures include metasurface elements.

15. The polarization imaging device of claim 12, wherein the aperture and the first metasurface are positioned on a same surface of a second substrate and wherein the folded optical path passes through the second substrate.

16. The polarization imaging device of claim 12, wherein the reflective surface is positioned to cover a portion of the first substrate, the planar diffractive lens surrounds the reflective surface, and the diffracted light reflects off the reflective surface, reflects off the reflective backside of the aperture and diffracts through the planar diffractive lens.

17. A calibration method comprising:
providing a raw image scene with various features each including known polarization signatures;
providing a polarization camera configured to diffract different polarizations of light into different portions of an image sensor;
sequentially illuminating various sub-field of views (FOVs) of the raw image scene;
measuring the incident light on the image sensor from light reflected from each sub-FOV; and
identifying a linear operator which corresponds the light sensed by the image sensor for each sub-FOV to the location and polarization of the light reflected off a portion of the raw image scene.

18. The calibration method of claim 17, wherein light incident on different portions of the image sensor translates depending on the position of the sub-FOV.

19. The calibration method of claim 17, wherein the light incident on different portions of the image sensor has an intensity signature based on the polarization of the light reflected from each sub-FOV.

20. The calibration method of claim 17, further comprising:
illuminating a sub-FOV of a second raw image scene;
measuring the incident light on the image sensor from light reflected from the sub-FOV of the second raw image scene; and
computing the position and polarization of the sub-FOV of the second raw image scene based on the computed linear operator.
